(19) United States
(12) Patent Application Publication
(10) Pub. No.: US 2004/0115307 A1
(43) Pub. Date: Jun. 17, 2004

(54) Effervescent hop tablet

(76) Inventor: James F. Boyd, Mabton, WA (US)

Correspondence Address: STRATTON BALLEW, 213 S 12TH AVE, YAKIMA, WA, 98902, US

(21) Appl. No.: 10/651,073

(22) Filed: Aug. 27, 2003

Related U.S. Application Data
(60) Provisional application No. 60/407,572, filed on Aug. 28, 2002.

(51) Int. Cl. C12G 1/00

(52) U.S. Cl. 426/15

(57) ABSTRACT

Effervescent formulations of hop adjuncts for use in the process of beer brewing, or more generally the manufacture or production of malt beverages. These manufacturing processes can include primary fermentation, when added to the wort, secondary fermentation, when added to the green beer, and storage, when added to beer. The effervescent product includes an effervescent material, such as a carbonate compound, combined with brewing kettle hop adjuncts. The hop adjuncts may include any combination of conventionally derived hop materials or extracts, including alpha acids, beta acids, resins and oils. Preferably, the effervescent formulations are formed into the shape of a tablet, and serve to simplify and improve the efficiency and metering of the hop adjuncts into the brewing process.

TECHNICAL FIELD

The invention relates to the use of a hop derived effervescent tablet in a malt beverage brewing process, such as the brewing of beer, and specifically to the use of carbonate compounds combined with hop adjuncts employed as brewing kettle additions, dry hopping materials, and in post brewing processing, to improve the efficiency, activity and metering of these hop adjuncts into any brewing process that relies on hop derived characteristics as a measure of quality in the brewing process.

### BACKGROUND OF THE INVENTION

Hops have long been utilized to impart bittering and aromatic essence to beer. Hop derived materials, with additional flavorings and processing agents, are typically employed in the conventional beer brewing process, and more generally in the manufacture of malted beverages. Collectively, hops and hop derived materials, flavorings and agents, in all various possible blends and formulations, can be referred to as “hop adjuncts.”

Traditionally, hops are employed in the brewing process as either a dried whole hop cone, or in the form of a mechanically compressed pellet. Alternatively, the hops can be employed in the form of a processed extract. Each of the existing methods, whether used alone or in combination, present complex challenges in attaining repeatable and cost efficient brewery practices. The style of the malted beverage such as ale, lager, and an ever-expanding number of hybrid fermented malt products, along with the design of the brewing system have a direct correlation as to the preferred manner in the addition of the hop adjuncts. Hop adjuncts in the form of whole cones, pellets or extract are usually added to the boiling wort in a brewing kettle. Additionally, or in the alternative, a purified selective fraction of hop extract may be added during the boil, after the boiling of the wort, or after fermentation “post kettle.”

Primary components of the whole hop employed in the brewery process include alpha acids, beta acids, resins and oils. These primary components are conventionally extracted from the whole hops in a solvent extraction process. Modem extraction processes employ carbon dioxide [CO₂] as a safe, flavorless and efficient extraction medium. CO₂ imparts no undesirable residuals in the extract.

Employing conventional techniques of post extraction processing, the hop extract is efficiently separated into an alpha acids fraction, and a beta acid oil (BAO) fraction. The BAO fraction is a desirable hop adjunct, often employed in modern “brewing” processes, which is the manufacture of beer, conventionally on a large, industrial scale. This BAO fraction is also referred to as the “aroma fraction,” as it contains the beta acids, essential hop oils and other hop compounds that contribute to a complex, “hoppy” character in the brewing of beer.

Typically, these hop adjuncts are introduced into the brewing kettle in one of several alternative forms. As mentioned above, whole hop cones are typically processed into a pelletized and sometimes freeze-dried form. These whole hop products must be thoroughly pulverized and then well mixed into the brewing kettle. This inclusion of a vegetative material into the wort results in the added expense of long boil times and necessitates settling or filtering to produce a high clarity product. Additionally the long boil time necessary to deliver sufficient bittering is deleterious to volatile aromatic components desired in the finished product. Additional vegetative material is sometimes introduced late in the boil to replace the volatile components destroyed in the boil. Whole hop cones or pellets may alternatively be added to the bright beer in a practice commonly referred to as dry hopping. While dry hopping is an option, dependant upon brewery design, it is an expensive and inefficient practice, poorly utilizing the hops, and additionally may necessitate clarification of the resultant beer. Extracts from the whole hops, on the other hand, generally comprise a thick, viscous material with a syrup or tar- like appearance. While hop extracts can be more efficiently used in bittering than whole hop cones or pellets, the extract is typically added early in the kettle boil and, therefore, makes for the same minimal contribution of aromatic components. Both whole hops product and extracts require special consideration and treatment to be introduced both effectively and late into the brewing kettle. Even with the use of best industry practice and methods in the addition of these hop adjuncts, there are presently unavoidable inefficiencies in current delivery methods. These inefficiencies often lead to inconsistency in final beverage quality.

An improved product is needed that provides for better distribution of the hop adjuncts into the brewing process. Such an improved product would not only increase the activity of a given amount of hop adjunct, but give the brewmaster the ability to more accurately control the brewing process, limiting variability in solubility and mixing from adversely impacting the finished product.

The above described hop adjuncts are typically introduced in “slugs” or whole measures into a batch or wort contained within the brewing kettle. The introduction of slugs of additives into the brewing kettle results in a system “shock,” or a wide swing of concentrations and reaction conditions within the brewing kettle. An improved product which allows for efficient, uniform delivery of hop adjuncts regardless of the brewery design and or beer style is needed that better meters the distribution of hop adjuncts into the brewing process, allowing the wort to evenly react and mix with the hop adjuncts though a controlled infusion, rather than a shock or slug treatment.

### DETAILED DESCRIPTION OF SPECIFIC EMBODIMENTS

The present invention provides effervescent formulations of hop adjuncts for use in a beer brewing process. With these effervescent formulations, an improved product and process of supplying hop adjuncts to the beer brewing process can be realized. For the present invention, “hop adjuncts” include the wide range of whole hops and hop-based products. These hop products and hop-derived products can be supplemented with processing agents typically employed in conventional beer brewing processes.

Products having the “effervescent formulations” employed in the present invention preferably include any effervescent materials that energetically evolve gasses upon contact with water. Any alkali metal carbonate or bicarbonate, effervescent material can be utilized for this purpose. A bicarbonate is preferred, as it evolves carbon dioxide gas upon contact with water. A potassium bicarbonate [KHCO₃] is a most preferred bicarbonate. A sodium bicarbonate [NaHCO₃] is less preferred to potassium bicarbonate, because potassium bicarbonate does not add sodium to the brewing kettle. However, sodium bicarbonate typically dissolves without residual “soapy-ness,” sometimes associated with potassium bicarbonate, and so blends of the bicarbonates can be employed to mitigate the negative aspects of each. Additionally, as an alternative to the alkali metal bicarbonate salts, an alkali-earth carbonate salt such as a calcium carbonate [CaCO₃] or a magnesium carbonate [MgHCO₃] can be employed. Any mixture of these effervescent materials can be utilized, again to best dissolve with a minimum of residue, as well known in the art of effervescent materials.

Additional “enhancers” can be added to the effervescent materials to aid in the activity of the effervescent formulation of the present invention. Organic acids, beyond those hop-derived acids present in the hop adjunct, can be added to the effervescent formulation to aid in the activity of the effervescent material. Citric acid, tartric acid and fumaric acid are examples of organic acids considered for use with the present invention.

In the brewing process, hops are initially introduced at the boiling of the wort. The boiling wort facilitates isomerization of the alpha-acids present in the hops to impart the hop characteristic to the resultant beverage, beer. Hops can then be added late in the wort boiling process to add more to the aroma of the beer, as much of the volatile components are lost during the vigorous boiling. These late kettle additions are known to be especially inefficient. The present invention greatly aids in the more effective utilization of the hop adjuncts through the energetic dissolution provided by the effervescent material incorporated in the tablets.

Specifically, the conventional addition of hop adjuncts to the brewing kettle either mass on the bottom of the kettle or float in the boiling layer at the top of the kettle, and depend on the roll of the boil for mixing. The present invention provides a multifold increase in the interfacial area between the hop adjunct and the wort. When introduced to the boil, the effervescent tablets containing the hop adjuncts fall to the bottom of the kettle, creating an energetic bubbling of the effervescent material. The mass transfer of the soluble components of the hop adjuncts into a liquid phase are greatly enhanced by the micro-bubble distribution. The interfacial area between the wort and the hop adjunct increases from the surface of the kettle, as is conventional, to also include the combined surface area of the entire bubble swarm. In addition to the boiling layer at the top of the brewing kettle, the large swarm of bubbles that emit from the dissolving effervescent formulation of the hop tablet significantly enhances the hop adjunct to wort interaction.

The product of the present invention can also be used as an alternative to dry hopping during maturation in the fermentation tanks. The rapid dissolution of the effervescent tablets at the elevated kettle temperatures provide a means of reducing boil time and a reduction in the need for expensive late addition hops, while increasing the content of volatile compounds without necessitating additional clarification. Conversely, the controlled low temperature of the fermentation tanks is also conducive to the utilization of the slow, uniform product delivery of the effervescent hop adjuncts. When used in the fermentation tanks, the present invention is capable of delivering hop adjuncts rich in volatile hop compounds over the course of many days without adding turbidity to the final beer or malt beverage.

In post-fermentation processing, the hop adjuncts are often employed to reduce off-flavors, adjust bitterness and improve foaming related properties of the brewed product. For bitterness adjustment, iso-alpha-acids are the preferred hop adjunct, which is a preferred component for mixing with the effervescent material for use with the present invention. Post fermentation processing typically lacks the vigorous agitation provided by the boiling wort and so the action provided by the dissolving of the effervescent material is a great aid to distributing the iso-alpha-acids or alternative hop adjuncts, into the brewed product.

Any hop extract obtained through a standard supercritical carbon dioxide extraction, or as a by-product of an extraction process, can be employed for the product and process of the present invention. The hop extract typically includes most of the oils, resins, fats and waxes that were present in the original hops. Alpha-acids are a vital flavoring component of the hop extract. These alpha-acids are also commonly called humulones, and include humulone, co-humulone, ad-humulone, prehumulone and post-humulone. The alpha-acids may be utilized in the brewing process, as prepared with the process of the present invention, and as extracted in their natural state. Alternatively, the alpha-acids may be hydrogenated to form hydrogenated-alpha-acids and then isomerized to form hydrogenated-iso-alpha-acids, which are preferred for longer storage life and a more desirable activity in the brewing kettle. Depending on the amount of hydrogen added to the compounds during reduction, the di-hydro, tetra-hydro, and hexa-hydro forms of the reduced and isomerized alpha-acids could also be utilized, with the tetra-hydro compounds typically preferred. The di-hydro-iso-alpha-acid is also known as rho-iso-alpha-acid, and as with the other reduced iso-alpha acids, is becoming widely accepted to enhance resistance to “lightstruck,” undesirable off-flavors in beer.

The beta-acids component of whole hops is also employed as flavoring agents and so can be incorporated for use with the present invention. Beta-acids include lupulone, co-lupulone, ad-lupulone, pre-lupulone and post-lupulone. It is also well known by persons skilled in the appropriate arts, that beta-acids may also be transformed into a variety of substances for a more desirable activity or result in the brewing kettle, such as the hydrogenated-alpha-acids discussed above.

Additionally, hop aroma components, hop oils, and hop polyphenols may all be included in the effervescent formulation of the present invention. Specifically, bio-flavanoids, gallo-tannins, and other aromatic compounds such as oxygenated terpenes, all present in hops, can be selectively extracted or otherwise refined from the whole hops and added to the hop adjunct of the effervescent formulation.

In a preferred embodiment, 1 parts of a mixture of hop oils and beta-acids, separated from a carbon dioxide extract of whole hops is combined with 1 part a mixture of sodium bicarbonate and binders, disintegrants, and excipients common in the trade. This resulting powder is compressed into a tablet utilizing a standard 2 cm diameter tablet press, to yield a hop tablet for use in a beer manufacturing process. The 2 cm diameter tablet is approximately 0.5 cm in thickness, but any appropriate diameter and thickness could be used for the purposes of the present invention.

The term “approximately” is used herein to refer to a range of values, understood by a person skilled in the pertinent field or skill, as being substantially equivalent to the herein stated values in achieving the desired results, or in a range typical to the accuracy and precision of conventional tooling or techniques.

An advantage of employing the beta acids oil fraction (BAO) is that they are substantially free of alpha acids. They do not contribute to “sun struck” or bitter off-flavors. Additionally, as preferred, the BAO can be “enriched,” or concentrated to have a higher and constant beta acids concentration, as compared to conventional, unmodified BAO.

As discussed above, any hop extract obtained through a standard supercritical carbon dioxide extraction, as a processed extraction product, or as a by-product of an extraction process, can be employed in the product and process of the present invention. Specifically, the alpha-acids component of the hop extract, preferably modified or processed to form hydrogenated- alpha-acids and hydrogenated-iso-alpha-acids could also be utilized as hop adjuncts in the product of the present invention. Additionally or in the alternative, the di-hydro, tetra-hydro and hexa-hydro forms of the reduced and isomerized alpha-acids, could also be utilized in the product of the present invention, with the “tetra-hydro” compounds typically preferred. Additional alternative alpha acids related hop adjuncts include the di-hydro-iso-alpha-acid or the rho-iso-alpha-acid. Any of these processed alpha acid products and related alpha acid adjuncts are collectively referred to herein as a modified alpha acid.

Considerations for selecting an appropriate tablet size include the desired metering or dissolving characteristics of the tablet. As larger tablets are somewhat difficult to break into exact portions, the smaller tablets have the advantage of precise measurement for addition into the brewing kettle, or in later maturation finishing. Larger tablets have the advantage of slower dissolving rates.

In a preferred alternative to the 2.6 cm diameter tablets, a larger tablet weighing approximately 0.5 kg or more could be utilized for the present invention. With larger tablets dissolving more slowly, the tablets release of the hop adjuncts into the wort is slowed to any desired rate. The rate of dissolution can be further altered by the selection of the effervescent materials to speed or slow the reaction of the effervescent formulation with the wort. Additionally, coatings on the tablet, layers within the tablet, and the geometry of the tablet can all influence the dissolution rate of the tablet, as well known by persons practiced in the manufacture of effervescent tablets.

A preferred formulation of the effervescent hop tablet includes 16% of the enriched BAO, the BAO having a beta acids concentration of 60%, 30% hop oils, and less than 2% alpha acids, as typically dictated by varietal and typical process variations. Again, all of the measurements discussed herein are approximate as defined above, and by weight unless noted otherwise, within conventional ranges encountered in sampling and testing methods, and must be adjusted in view of crop and varietal variations. For this preferred formulation, a 4:1 mixture of sodium bicarbonate and calcium carbonate are included as effervescent materials, totaling approximately 49% of the final formulation. Approximately 9% of the formulation is citric acid, added as a buffering agent and pH neutralizer. A small quantity, approximately 4% of magnesium stearate, or alternatively stearic acid, is added for anti-caking. A small amount of silicon dioxide, approximately up to 10%, added to help tablet formation. Most preferably, to further enhance the activity of the effervescent hop tablet, a simple sugar, such as lactose or dextrose, or alternatively sorbitol, is also added, at approximately 2%. Approximately 3% cellulose and approximately 8% di-calcium phosphate are also added, as optional ingredients.

The above listed formulation is dry mixed in a high shear mixer and metered into a standard tablet press, to form a preferred tablet, the size variable to suit the processing needs, as discussed herein. Certain conventional refinements and alternatives to the above listed ingredients and component concentrations, as would be practiced by those skilled in the field of effervescent tablet formulation, are considered within the scope of the present invention.

A preferred packaging of the effervescent tablet product, for use in the present invention, includes approximately 200 of the 5.0 gm tablets in a 1 kg net total weight foil pouch, which is vacuum sealed to prevent contact with moisture and maintain the freshness of the tablets within. As an alternative, the pouches can be charged with an inert gas, such as nitrogen, to displace any oxygen present in the pouch. The pouches are most preferably kept refrigerated, or at least cooled, to further discourage oxidative decay of the hop adjuncts, as typically encountered over time.

The foil pouch is a preferred container, compared to the conventional “pail” or can. The use and proper disposal of the conventional containers presents increasing difficulties. The pails or cans must be punctured or opened, and drained or scooped into the kettle. Product loss through spilling and poor material transfer is common. The empty can or container then creates a waste problem and must be disposed of or returned for recycle. The preferred foil pouch can be resealed if not completely used. The emptied pouch collapses flat and efficiently recycled or disposed.

The process of the present invention includes introducing or adding the effervescent hop tablet product into the wort, at an appropriate point in the processing of the beer beverage. As discussed above, the effervescent hop tablets are preferably introduced into the brewing kettle as a substitute for traditional bulk additions of equivalent doses of the same, typical hop adjuncts. However, unlike conventional non-effervescing hop adjuncts, a charge of the hop tablets of the present invention dissolve with a high activity of bubbles, leaving a minimum of residue.

In an example of a preferred process of the present invention, 0.5 Kg of the effervescent hop tablets are added to the equivalent of 10,000 liters of finished beer, approximately 10 to 15 minutes before kettle break. In this case, the objective is to provide economic anti-foaming activity and enhance kettle break and trub formation. When introduced late in process of kettle boil or at the whirlpool, the effervescent hop tablets provide the desirable “hoppy” aroma characteristics to the beer, and related “notes” of taste and smell.

In an alternative to introducing the effervescent hop tablet product of the present invention into the primary tank or fermenter, the effervescent hop tablets can be employed as a replacement for conventional dry hopping products. In an example of this alternative preferred process, the effervescent hop tablets are added directly into the secondary fermenter or maturation tank, also referred to as the green beer or “bright beer” tank. Approximately 20%, by weight, less than the typical weight of loose hops or hop pellets can be added to the tank to achieve equivalent results, with the additional benefits of improved flavor quality and much less residual. The improvements of economy are directly related to the efficiency of the effervescence as a delivery mechanism into the brew. The effervescent hop tablets begin disintegrating almost immediately. Depending upon temperature, the complete dissolution of the tablets takes place over a period of three to five days. As a variant to this method of direct addition to the tank, the effervescent hop tablets can be dissolved in hot water, preferably under agitation, and the resulting solution dosed into the beer process stream. This introduction preferably occurs just before filtration, after the secondary fermentation.

After the conventional brewing process, in storage, lagering, in keg filling or in bottling, the product of the present invention can be utilized to further enhance the qualities of the beer. Individual tablets or multiple of effervescent hop tablets, depending on the effect desired, can be added to the stored beer.

In an example of this preferred alternative use of the effervescent hop tablets of the present invention, nine of the 5 gm tablets were added to a U.S. standard, 15.5 gallon keg. The keg was then stored for 5 days. The effervescent character of the product assured uniform delivery of the hop adjuncts. The result was an enhanced beer with the desired effect of elevated hoppy characteristics.

The efficiency of the effervescent hop tablets in any stage of brewing is further enhanced by the purity of the effervescent hop tablets. The carbon dioxide extraction process essentially eliminates microbial populations, the possibility of residual pesticides and chemical contaminants, potentially found in whole hops. Compliance with the strictest of food safety regulation is insured by the substitution of the effervescent hop tablets of the present invention, as compared to conventional leaf or whole hop materials.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible which employ the same inventive concepts as described above. Therefore, the invention is not to be limited except by the claims as will be filed in related applications, as appropriately interpreted in accordance with the doctrine of equivalents.

What is claimed is:

1. An effervescent hop product for the improved delivery of hop adjuncts, the product comprising:
an effervescent material combined with a hop adjunct, the effervescent material including
a carbonate salt of an alkali metal, and the hop adjunct including a hop derrived material;
and the product for use in a manufacture of a malt beverage.

2. The product of claim 1, wherin the hop adjunct includes a carbon dioxide extract of a hop.

3. The product of claim 1, wherein the product is pressed into a tablet form.

4. The product of claim 1, wherin the hop adjunct includes at least one of the following components: alpha-acids, beta-acids, hop aroma componds, and hop polypenols.

5. The product of claim 1, wherein the formulation is added to a wort, the wort formed in the manufacture of the malt beverage.

6. The product of claim 1, wherein the malt beverage is a beer.

7. The product of claim 1, wherein the hop adjunct includes a hop aroma extract.

8. The product of claim 7, wherein the hop aroma extract includes a concentrated beta-acids component.

9. The product of claim 1, wherein the hop adjunct includes a beta acid oil.

10. The product of claim 1, wherein the hop adjunct includes a modified alpha acid.

11. An effervescent hop product for the improved delivery of hop adjuncts, the product comprising:
an effervescent material combined with a hop adjunct, the effervescent material including
a carbonate salt of an alkali metal, and the hop adjunct including a hop derrived material;
and the product added to a wort in a beer brewing process.

12. The product of claim 11, wherin the hop adjunct includes a carbon dioxide extract of a hop.

13. The product of claim 11, wherein the product is pressed into a tablet form.

14. The product of claim 11, wherin the hop adjunct includes at least one of the following components: alpha-acids, beta-acids, hop aroma componds, and hop polypenols.

15. The product of claim 11, wherein the hop adjunct includes a hop aroma extract.

16. The product of claim 15, wherein the hop aroma extract includes a concentrated beta-acids component.

17. The product of claim 11, wherein the hop adjunct includes a beta acid oil.

18. The product of claim 11, wherein the hop adjunct includes a modified alpha acid.

19. An effervescent hop product for the improved delivery of hop adjuncts, the product comprising:
an effervescent material combined with a hop adjunct, the effervescent material including
a carbonate salt of an alkali metal, and the hop adjunct including a hop derrived material;
and the product added to a malt beverage.

20. The product of claim 19, wherin the hop adjunct includes a carbon dioxide extraction of a hop.

21. The product of claim 19, wherein the product is pressed into a tablet form.

22. The product of claim 19, wherin the hop adjunct includes at least one of the following components: alpha-acids, beta-acids, hop aroma componds, and hop polypenols.

23. The product of claim 19, wherein the malt beverage is a beer.

24. The product of claim 19, wherein the hop adjunct includes a hop aroma extract.

25. The product of claim 24, wherein the hop aroma extract includes a concentrated beta-acids component.

26. The product of claim 19, wherein the hop adjunct includes a beta acid oil.

27. The product of claim 19, wherein the hop adjunct includes a modified alpha acid.
